(19) United States
(12) Patent Application Publication
(10) Pub. No.: US 2024/0233451 A1
(43) Pub. Date: Jul. 11, 2024

(54) GATEWAY SAFETY CIRCUIT, GATEWAY SAFETY DEVICE, AND VEHICLE EMPLOYING DEVICE

(71) Applicants: Futaijing Precision Electronics (Yantai) Co., Ltd., Yanfai (CN); HON HAI PRECISION INDUSTRY CO., LTD., New Taipei (TW)

(72) Inventors: SHIH-YU LU, New Taipei (TW); TIEN-CHI TSOU, New Taipei (TW)

(21) Appl. No.: 18/218,617

(22) Filed: Jul. 6, 2023

(30) Foreign Application Priority Data
Jan. 9, 2023 (CN) 202320050561.7

(51) Int. Cl. G07C 5/00; G07C 5/08

(52) U.S. Cl. CPC G07C 5/008; G07C 5/0808

(57) ABSTRACT

A gateway security circuit for isolating an internal vehicle domain and an external vehicle domain comprises a first communication interface, a second communication interface, and a communication module. The communication module comprises an intranet domain controller electrically connected with the first communication interface and an external domain controller electrically connected with the second communication interface. The intranet domain controller is configured to communicate with the in-vehicle communication system of a vehicle, and the external domain controller is configured to communicate with the out-of-vehicle communication system of the vehicle. intranet domain controller and the external domain controller respectively control the data transmission with the in-vehicle communication system and the out-vehicle communication system, realizing the isolation of the intranet domain controller and the external domain controller, avoiding the cross transmission of data, reducing the risk of vehicle intrusion. A gateway security device and the vehicle are also provided.

### TECHNICAL FIELD

The subject matter herein generally relates to gateways of vehicle.

### BACKGROUND

Vehicles are developing from semi-autonomous driving to eventually fully autonomous driving with the improvement of the vehicle system architecture. To enhance interconnection ability and communication ability of the vehicle, more and more functions are added such as smart access, vehicle sharing, predictive maintenance, vehicle tracking, fleet management, and Over-the-Air technology upgrade. The amount of data generated by these functions is increasing, and data transmitted by the Ethernet network between the internal and external vehicle domains is also increasing. If there is no effective network security protection, the vehicle system architecture may be illegally invaded by external data during data transmission between the internal and external domains, resulting in vehicle loss of control and even casualties.

### BRIEF DESCRIPTION OF THE DRAWINGS

Implementations of the present technology will now be described, by way of example only, with reference to the attached figures.

FIG. 1 is a diagram of one embodiment of a gateway security circuit according to the present application.

FIG. 2 is a diagram of one embodiment of a communication module according to the present application.

FIG. 3 is a diagram of one embodiment of a gateway security device according to the present application.

FIG. 4 is a diagram of one embodiment of a vehicle according to the present application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

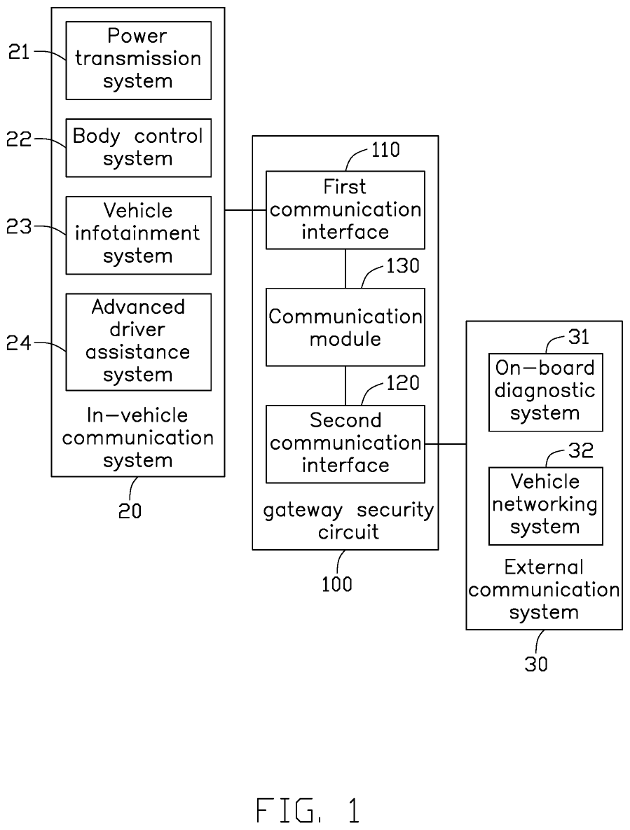

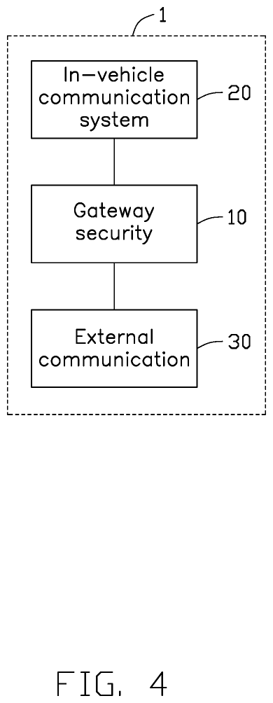

FIG. 1 is a diagram of a gateway security circuit 100 in one embodiment of the present application. The gateway security circuit 100 can be set in a vehicle 1 (as shown in FIG. 4). The vehicle 1 comprises an in-vehicle communication system 20 and an out-of-vehicle communication system 30. The gateway security circuit 100 is configured to communicate with the in-vehicle communication system 20 and the out-of-vehicle communication system 30.

The gateway security circuit 100 comprises a first communication interface 110, a second communication interface 120, and a communication module 130. The first communication interface 110 is configured to electrically connect with the in-vehicle communication system 20. The second communication interface 120 is configured to electrically connect with the out-of-vehicle communication system 30. The communication module 130 comprises an intranet domain controller 131 electrically connected with the first communication interface 110 and an external domain controller 132 electrically connected with the second communication interface 120. The intranet domain controller 131 is configured to communicate with the in-vehicle communication system 20, and the external domain controller 132 is configured to communicate with the out-of-vehicle communication system 30.

The first communication interface 110 or the second communication interface 120 can be an Ethernet connector. The intranet domain controller 131 transmits data to the in-vehicle communication system 20 through the first communication interface 110. For example, the in-vehicle communication system 20 comprises a power transmission system 21, a body control system 22, a vehicle infotainment system 23, and an advanced driver assistance system 24. The intranet domain controller 131 can receive the working data from the power transmission system 21, the body control system 22, the vehicle infotainment system 23, and the advanced driver assistance system 24 through the first communication interface 110, and output the working data to the external domain controller 132.

The external domain controller 132 can communicate with the external vehicle communication system 30 through the second communication interface 120 to send the working data to a mobile terminal or upload the working data to a cloud server through the external vehicle communication system 30. The external domain controller 132 can communicate with the out-of-vehicle communication system 30 through the second communication interface 120. For example, the out-of-vehicle communication system 30 can receive the communication data (such as control signals, audio and video information, etc.) sent by the mobile terminal or the cloud server, and the external domain controller 132 can receive the communication data through the second communication interface 120 and output the communication data to the in-vehicle communication system 20, so that the in-vehicle communication system 20 can perform the corresponding operation. In this way, the intranet domain controller 131 and the external domain controller 132 can respectively control the data transmission of the in-vehicle communication system 20 and the out-of-vehicle communication system 30, to realize an isolation of the internal vehicle domain and the external vehicle domain, avoid the cross-transmission of data, and reduce a risk of vehicle intrusion, and realize a safe and reliable data transmission between the in-vehicle communication system 20 and the out-of-vehicle communication system 30.

In one embodiment, the communication module 130 can be implemented by a module comprising a NXPS32G2 chip.

In one embodiment, the out-of-vehicle communication system 30 comprises an on-board diagnostic system 31 and a vehicle networking system 32, and the external domain controller 132 further comprises a first subdomain controller 132a and a second subdomain controller 132b. The first subdomain controller 132a is electrically connected to the on-board diagnostic system 31 for communication with the on-board diagnostic system 31. The second subdomain controller 132b is electrically connected to the vehicle networking system 32 for communication with the vehicle networking system 32.

It is understood that multiple subsystems of the out-of-vehicle communication system 30 may belong to different domains, and there may be security risks if data from different domains are transmitted through the same domain controller. The gateway security circuit 100 uses the first subdomain controller 132a and the second subdomain controller 132b to respectively communicate with the vehicle diagnostic system 31 and the vehicle networking system 32, to realize data transmission in different domains, and further improve the security of data transmission between the vehicle communication system 20 and the vehicle communication system 30.

The gateway security circuit 100 can realize the isolation of the internal vehicle domain and the external vehicle domain by the internal domain controller 131 and the external domain controller 132, controlling the data transmission of the in-vehicle communication system 20 and the external vehicle communication system 30 respectively, so as to avoid data cross transmission, reduce the risk of vehicle intrusion, and then realize the safe and reliable data transmission between internal vehicle communication system 20 and external vehicle communication system 30.

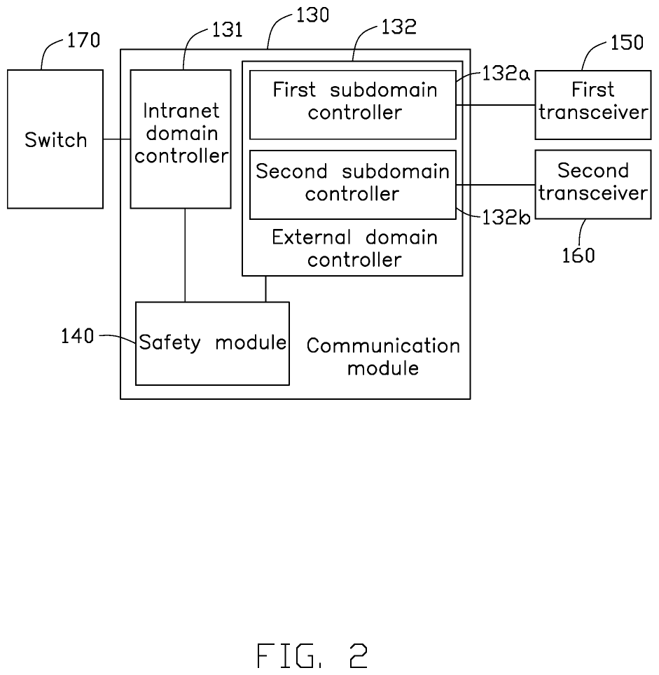

FIG. 2 is a diagram of one embodiment of a communication module 130.

In one embodiment, the communication module 130 comprises a safety module 140 electrically connected with the intranet domain controller 131 and the external domain controller 132, the safety module 140 is configured to encrypt a first communication data output by intranet domain controller 131 and the external domain controller 132, and decipher a second communication data received by intranet domain controller 131 and the external domain controller 132.

In this embodiment, the first communication data output by the internal domain controller 131 and the external domain controller 132 can be encrypted by security module 140, and the second communication data received by the internal domain controller 131 and the external domain controller 132 can be decrypted by the security module 140. In this way, the data transmitted between the internal vehicle domain and the external vehicle domain can be encrypted/decrypted through the security module 140, the security of data transmission can be improved.

In one embodiment, the gateway security circuit 100 further comprises a first transceiver 150 electrically connected with the first subdomain controller 132a and the on-board diagnostic system 31, the first transceiver 150 is configured to transmit a third communication data output by the first subdomain controller 132a to the on-board diagnostic system 31, and transmit a forth communication data output by the on-board diagnostic 31 to the first subdomain controller 132a. The first transceiver 150 can be a 1000Base-T1 PHY transceiver.

In one embodiment, the gateway security circuit 100 further comprises a second transceiver 160 electrically connected with the second subdomain controller 132b and the vehicle networking system 32, the second transceiver 160 is configured to transmit a fifth communication data output by the second subdomain controller 132b to the vehicle networking system 32, and transmit a sixth communication data output by the vehicle networking system 32 to the second subdomain controller 132b. The second transceiver 160 can be a 1000Base-T1 PHY transceiver.

In one embodiment, the gateway security circuit 100 further comprises a switch 170 electrically connected with the first communication interface 110 and the intranet domain controller 131. The switch 170 is configured to exchange a seventh communication data between the in-vehicle communication system 20 and the intranet domain controller 131.

In this embodiment, the switch 170 can provide an exclusive electrical signal path for any two network nodes accessing the switch 170, thus realizing the communication data exchange between the in-vehicle communication system 20 and the intranet domain controller 131.

In one embodiment, the in-vehicle communication system 20 may comprise a power transmission system 21, a body control system 22, a vehicle infotainment system 23, and an advanced driver assistance system 24. The switch 170 can also realize the data transmission between the power transmission system 21, the body control system 22, the vehicle infotainment system 23 and the advanced driver assistance system 24.

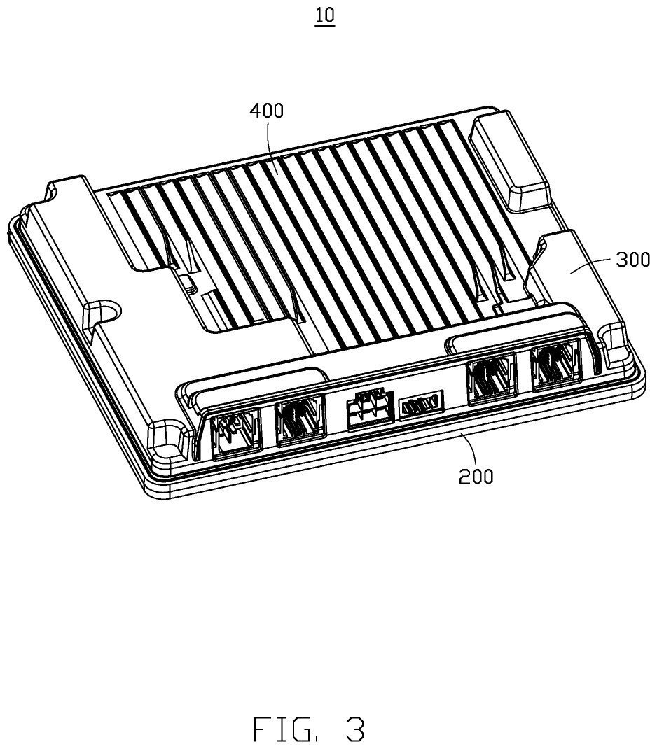

FIG. 3 is a diagram of one embodiment of a gateway security device 10.

The gateway security device 10 comprises a circuit board 200, a shell 300, and a gateway security circuit 100. The shell 300 and the circuit board 200 are enclosed to form a cavity, and the gateway security circuit 100 is arranged on the circuit board in the cavity. Thus, the gateway security circuit 100 can be protected from being damaged by dust particles in the air or external force collision.

In one embodiment, the gateway security device 10 further comprises a heat dissipation module 400, the heat dissipation module 400 is arranged on the shell 300 corresponding to a place of the gateway safety circuit 100, and the heat dissipation module 400 is configured to dissipate heat of the gateway security circuit 100.

The gateway security circuit 100 needs to process a large amount of data, and may generate heat within the shell 300 when working, resulting in temperature rising in the shell 300. Electronic components, such as capacitors and transistors are sensitive to temperature, and higher temperatures may affect their performance. By setting a heat dissipation module 400 on the shell 300, the heat in the shell 300 can be dissipated more quickly to the outside of the shell 300, so as to realize the heat dissipation of the gateway safety circuit 100 and improve the circuit stability. For example, the heat dissipation module 400 can choose a fin radiator.

In one embodiment, the shell 300 can be made of metal material, and the heat dissipation module 400 can be integrated with the shell 300 to improve the heat dissipation performance through the rapid thermal conductivity characteristics of the metal material.

FIG. 4 is a diagram of one embodiment of a vehicle 1.

The vehicle 1 comprises an in-vehicle communication system 20, an out-of-vehicle communication system 30, and a gateway security device 10. The gateway security device 10 is configured to communicate with the in-vehicle communication system 20 and the out-of-vehicle communication system 30.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A gateway security circuit applied to a vehicle, the vehicle comprising an in-vehicle communication system and an out-of-vehicle communication system, the gateway security circuit comprising:
a first communication interface configured to electrically connect with the in-vehicle communication system;
a second communication interface configured to electrically connect with the out-of-vehicle communication system; and
a communication module, wherein the communication module comprises an intranet domain controller electrically connected with the first communication interface and an external domain controller electrically connected with the second communication interface, the intranet domain controller is configured to communicate with the in-vehicle communication system, and the external domain controller is configured to communicate with the out-of-vehicle communication system.

2. The gateway security circuit of claim 1, wherein the out-of-vehicle communication system comprises an on-board diagnostic system and a vehicle networking system, and the gateway security circuit further comprises a first subdomain controller electrically connected with the on-board diagnostic system and a second subdomain controller electrically connected with the vehicle networking system, the first subdomain controller is configured to communicate with the on-board diagnostic system, and the second subdomain controller is configured to communicate with the vehicle networking system.

3. The gateway security circuit of claim 1, wherein the communication module further comprises a safety module electrically connected with the intranet domain controller and the external domain controller, the safety module is configured to encrypt first communication data outputted by the intranet domain controller and the external domain controller, and decipher second communication data received by the intranet domain controller and the external domain controller.

4. The gateway security circuit of claim 2, further comprising a first transceiver electrically connected with the first subdomain controller and the on-board diagnostic system, wherein the first transceiver is configured to transmit third communication data outputted by the first subdomain controller to the on-board diagnostic system, and transmit fourth communication data outputted by the on-board diagnostic to the first subdomain controller.

5. The gateway security circuit of claim 2, further comprising a second transceiver electrically connected with the second subdomain controller and the vehicle networking system, wherein the second transceiver is configured to transmit fifth communication data outputted by the second subdomain controller to the vehicle networking system, and transmit sixth communication data outputted by the vehicle networking system to the second subdomain controller.

6. The gateway security circuit of claim 1, wherein the communication module further comprises a switch electrically connected with the first communication interface and the intranet domain controller, and the switch is configured to exchange seventh communication data between the in-vehicle communication system and the intranet domain controller.

7. The gateway security circuit of claim 1, wherein the communication module comprises a NXPS32G2 chip.

8. A gateway security device applied to a vehicle, comprising a circuit board, a shell, and a gateway security circuit, the shell and the circuit board are enclosed to form a cavity, and the gateway security circuit is arranged on the circuit board and further located in the cavity, the vehicle comprising an in-vehicle communication system and an out-of-vehicle communication system, and the gateway security circuit comprising:
a first communication interface configured to electrically connect with the in-vehicle communication system;
a second communication interface configured to electrically connect with the out-of-vehicle communication system; and
a communication module, wherein the communication module comprises an intranet domain controller electrically connected with the first communication interface and an external domain controller electrically connected with the second communication interface, the intranet domain controller is configured to communicate with the in-vehicle communication system, and the external domain controller is configured to communicate with the out-of-vehicle communication system.

9. The gateway security device of claim 8, further comprising a heat dissipation module, wherein the heat dissipation module is arranged on the shell corresponding to a place of the gateway safety circuit, and the heat dissipation module is configured to dissipate heat of the gateway security circuit.

10. The gateway security device of claim 8, wherein the out-of-vehicle communication system comprises an on-board diagnostic system and a vehicle networking system, and the gateway security circuit further comprises a first subdomain controller electrically connected with the on-board diagnostic system and a second subdomain controller electrically connected with the vehicle networking system; the first subdomain controller is configured to communicate with the on-board diagnostic system, and the second subdomain controller is configured to communicate with the vehicle networking system.

11. The gateway security device of claim 8, wherein the communication module further comprises a safety module electrically connected with the intranet domain controller and the external domain controller, wherein the safety module is configured to encrypt first communication data outputted by the intranet domain controller and the external domain controller, and decipher second communication data received by the intranet domain controller and the external domain controller.

12. The gateway security device of claim 10, further comprising a first transceiver electrically connected with the first subdomain controller and the on-board diagnostic system, wherein the first transceiver is configured to transmit third communication data outputted by the first subdomain controller to the on-board diagnostic system, and transmit fourth communication data outputted by the on-board diagnostic to the first subdomain controller.

13. The gateway security device of claim 10, further comprising a second transceiver electrically connected with the second subdomain controller and the vehicle networking system, wherein the second transceiver is configured to transmit fifth communication data outputted by the second subdomain controller to the vehicle networking system, and transmit sixth communication data outputted by the vehicle networking system to the second subdomain controller.

14. The gateway security device of claim 8, wherein the communication module further comprises a switch electrically connected with the first communication interface and the intranet domain controller, and the switch is configured to exchange seventh communication data between the in-vehicle communication system and the intranet domain controller.

15. The gateway security device of claim 8, wherein the communication module comprises a NXPS32G2 chip.

16. A vehicle, comprising an in-vehicle communication system, an out-of-vehicle communication system, and a gateway security device, the gateway security device comprising a circuit board, a shell, and a gateway security circuit, the shell, and the circuit board are enclosed to form a cavity, and the gateway security circuit is arranged on the circuit board and further located in the cavity, the gateway security circuit comprising:
a first communication interface configured to electrically connect with the in-vehicle communication system;
a second communication interface configured to electrically connect with the out-of-vehicle communication system; and
a communication module, wherein the communication module comprises an intranet domain controller electrically connected with the first communication interface and an external domain controller electrically connected with the second communication interface, the intranet domain controller is configured to communicate with the in-vehicle communication system, and the external domain controller is configured to communicate with the out-of-vehicle communication system.
